(19) United States
(12) Patent Application Publication
(10) Pub. No.: US 2003/0145566 A1
(43) Pub. Date: Aug. 7, 2003

(54) Disposable filtration bag

(76) Inventors: David P. Parks, North Canton, OH (US); Jackson W. Wegelin, Akron, OH (US)

Correspondence Address: A. Burgess Lowe, 101 East Maple Street, North Canton, OH, 44720, US

(21) Appl. No.: 10/067,186

(22) Filed: Feb. 4, 2002

(51) Int. Cl. B01D 46/02

(52) U.S. Cl. 55/382; 55/486; 15/347

(57) ABSTRACT

A novel construction of a disposable filtration bag made from a sheet of composite material comprised of at least one layer of expanded polythtraflouroethylene (ePTFE) and at least one substrate layer. In the preferred embodiment of the invention, a conventional disposable filtration bag is provided for use in floor care appliances such as upright and canister vacuum cleaners. In an alternate embodiment, a “pillow case” type disposable filtration bag is provided for use in floor care appliances such as upright and canister vacuum cleaners. Two methods of construction of the “pillow case” type disposable filtration bag are provided wherein in one method of construction the composite sheet is folded twice and sealed, and in the other, the composite sheet is folded once and sealed to form the disposable filtration bag.

### FIELD OF THE INVENTION

Generally, the invention relates to filters and filtration. Particularly, in the preferred embodiment, the invention relates to a novel construction of a disposable vacuum cleaner filtration bag made from a composite sheet comprised of at least one a layer of expanded polytetraflouroethylene (ePTFE) and at least one substrate layer. In an alternate embodiment of the invention, a composite sheet is formed into a disposable vacuum cleaner filtration bag known as the “pillow case” type filtration bag.

### BACKGROUND OF THE INVENTION

Filtration bags for vacuum cleaners and floor care appliances and the like are well known in the art. Along with other improvements being made to vacuum cleaners due to advancements in technology has come an increased interest in improving the filtration ability of the filtration media employed therein. The filtration media typically employed are filtration bags or cartridges. The filtration cartridge is used exclusively to separate dirt particles while the filtration bag is used to separate and collect the dirt particles picked up by the nozzle of the vacuum cleaner before the working air is exhausted to the atmosphere.

There have been many improvements to the filtration bag including the materials the bag is constructed from. Such filtration bags have been known to improve the filtration efficiency dramatically. More recent advancements in filtration technology has yielded polytetraflouroethylene (PTFE) bonded to a substrate as an effective filtration membrane for filters and filtration systems. For example, the use of PTFE as a filtration material can be found in U.S. Pat. No. 6,030,484 issued to Maeoka et al. Even more recent advancements in filtration materials has produced expanded polytetraflouroethylene (ePTFE) as a filtration media which can filter dirt particles down to the limits of current measurement technology.

Typically, a filtration media such as a regeneratable filtration bag used in “bag house” operations is produced by an ePTFE membrane being bonded to a substrate as in U.S. Pat. No. 4,983,434 issued to Sassa, or without a backing as in U.S. Pat. No. 6,110,243 issued to Wnenchak et al. wherein an ePTFE membrane is supported by a support cage made of metal or plastic, or a combination of both a support cage and substrate to produce a filtration cartridge as in U.S. Pat. No. 4,878,930 issued to Manniso et al.

However, as with PTFE type filtration media, filtration media made with ePTFE used in regeneratable application must be occasionally cleaned of the dust cake that builds up on the filtration surface which causes a reduction in airflow efficiency. The methods and apparatus employed to clean the filtration media of dust cake build up include reverse airflow, pulse jet cleaning or a shaker mechanism. In the design and manufacture of floor care appliances such as vacuum cleaners, the addition of such apparatus can add considerable expense which is undesirable in a highly competitive market. The consumer may also find this undesirable and also inconvenient to have to occasionally clean the filtration media. Many consumers prefer disposable type filtration bags which do not require cleaning. After the filtration bag is full it is simply discarded and a new one is installed in the cleaner.

It is heretofore unknown to use a membrane of (ePTFE) as a filtration media for a disposable vacuum cleaner filtration bag. Such bags would provide superior filtration capability for vacuum cleaners yet provide the consumer with the convenience of a disposable filtration bag. Accordingly, there is a need in the art for a disposable filtration bag for a floor care appliance constructed from a membrane of (ePTFE).

Objectives of the invention include providing a new and improved disposable filtration bag with a “HEPA” filtration rating.

A still further objective is to provide a new and improved disposable filtration bag for floor care appliances which is constructed of a membrane of expanded polytetraflouroethylene (ePTFE).

### SUMMARY OF THE INVENTION

In carrying out the invention in aspect thereof, these objectives and advantages are obtained by providing a disposable filtration bag which is constructed of a membrane of expanded polytetraflouroethylene (ePTFE) achieving a level of filtration not heretofore achieved.

In the preferred embodiment of the invention, a composite sheet comprised of at least one layer of ePTFE and at least one substrate layer is fashioned into a filtration bag for installation in a floor care appliance such as a vacuum cleaner.

In an alternate embodiment of the invention, a “pillow case” type filtration bag is formed from a composite sheet of material comprised of at least one ePTFE membrane layer and at least one substrate layer. The composite sheet is folded and sealed along overlapping edges, the top, and the bottom to form the filtration bag. In an alternate method of construction, the “pillow case” type filtration bag is formed by folding the composite sheet over along a single edge and sealing the resulting three sides.

### BRIEF DESCRIPTION OF DRAWINGS

Embodiments of the invention, illustrative of several modes in which applicants have contemplated applying the principles are set forth by way of example in the following description and are shown in the drawings and are particularly and distinctly pointed out and set forth in the appended claims.

FIG. 1 is a front elevated perspective view of a disposable filtration bag, according to the preferred embodiment of the invention;

FIG. 2 is a rear elevated perspective view of a disposable filtration bag, according to the preferred embodiment of the invention;

FIG. 3 is a is a cutaway view of the disposable filtration bag of FIG. 2 taken along line 3-3 of FIG. 2, according to the preferred embodiment of the present invention;

FIG. 4 is a front elevated perspective view of a disposable filtration bag, according to an alternate embodiment of the present invention;

FIG. 5 is a rear elevated perspective view of a disposable filtration bag, according to an alternate embodiment of the present invention;

FIG. 6 is a cutaway view of the disposable filtration bag of FIG. 5 taken along line 6-6 of FIG. 5, according to an alternate embodiment of the present invention;

FIG. 7a is an exploded view of the preferred embodiment of a method of construction of the disposable filtration bag shown in FIG. 5, according to the preferred embodiment of the present invention;

FIG. 7b is an assembled view of the rear side of the preferred embodiment of the method of construction of the disposable filtration bag shown in FIG. 5, according to an alternate embodiment of the present invention;

FIG. 8a is an exploded view of an alternate embodiment of a method of construction of the disposable filtration bag similar in style to that shown in FIG. 5, according to an alternate embodiment of the present invention; and

FIG. 8b is an assembled view of the front side of an alternate embodiment of a method of construction of the disposable filtration bag similar in style to that shown in FIG. 5, according to an alternate embodiment of the present invention.

### DESCRIPTION OF THE PREFERRED EMBODIMENT

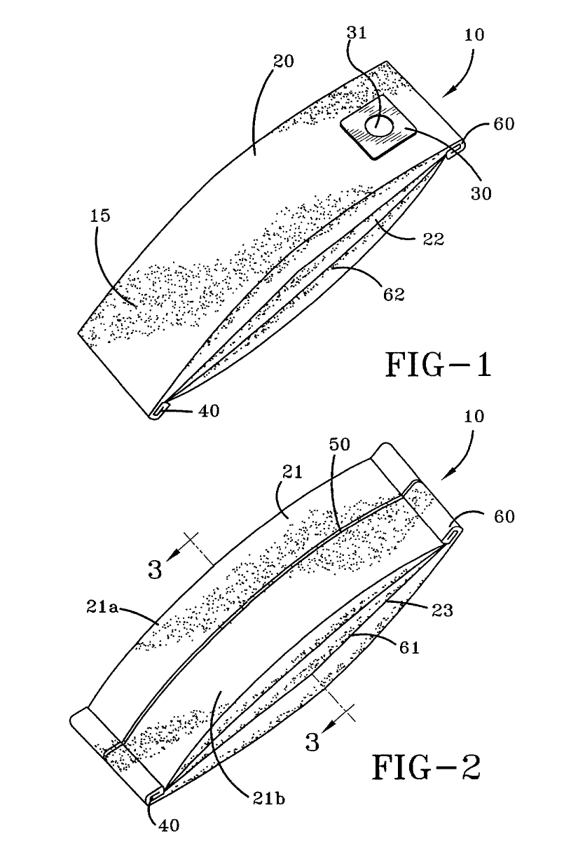

Referring to FIGS. 1 and 2, shown is a disposable filtration bag 10, according to the preferred embodiment of the present invention, for use in a commercial or home floor care appliance such as an upright vacuum cleaner, such as the vacuum cleaner disclosed in U.S. Pat. No. 4,452,618, owned by a common assignee, and incorporated by reference fully herein. Properly designed similar disposable filtration bags could also be used in canister cleaners, stick cleaners, central vacuum cleaners, and others. Typically, filtration bags such as the one shown in FIGS. 1 and 2 are made from a composite sheet 15 of material having filtration qualities and so that there exists a smooth front sidewall 20, a rear sidewall 21 having a seam 50 connecting opposing first and second rear panel portions (21a, 21b), and a pair of pleated sidewalls 22,23 having one or more pleats 61,62 extending the length of front and rear sidewalls 20,21. The pleats 61,62 extend from a top fold 60 at one end of filtration bag 10 to a bottom fold 40 at the opposite end of filtration bag 10. Folds 40,60 may then be secured using adhesive, heat bonding, or other suitable methods. End folds 40,60 can be to the rear (as shown), to the front, or one each way. Front sidewall 20, rear sidewall 21, and pleated sidewalls 22, 23 are sealed at opposing ends by folds 40,60 and together form an enclosed interior volume 11 (FIG. 3) wherein dirt particles are collected. The dirt particles along with the working air from the nozzle of the vacuum cleaner or floor care appliance enter the filtration bag 10 through an aperture 31 in the front sidewall 20 of the filtration bag 10. A collar 30 made from a sheet of stiffer material such as cardboard may be used to reinforce the perimeter of aperture 31 and provide a means by which filtration bag 10 may be supported within the vacuum cleaner and to also hold filtration bag 10 and aperture 31 in alignment with the working air duct of the vacuum cleaner (not shown). Collar 30 may be composed of a single layer of stiff material, or multiple layers of a variety of materials such as a “sandwich” design with a flexible, stretchable material with a smaller diameter aperture on the inside or outside. In an alternate embodiment of the invention (not shown), collar 30 maybe replaced by an inlet tube formed from the same or different material as front and rear sidewalls 20,22 which then connects aperture 31 to the working air duct of the vacuum cleaner or floor care appliance (not shown). The working air is able to exit interior 11 of filtration bag 10 through filtration material 15 while dirt particles are trapped within interior 11.

Referring now to FIG. 3, to improve the filtration ability of filtration bags such as filtration bag 10 shown in FIGS. 1 and 2, at least one thin membrane layer 15b of expanded polytetraflouroeethylene (ePTFE) and at least one layer of a suitable substrate 15a (such as polyester spunbond, cellulose, cellulose and synthetic fibers, bicomponent polyester, synthetic polyester, synthetic polyolefin, synthetic nylon, or others) form a composite filtration sheet 15. An ePTFE membrane has superior gas filtration characteristics being known to be 99.97% efficient or greater for particles as small as 0.3 microns or smaller but is very fragile. In order to use the ePTFE membrane 15b as a filtration material, it must be used in conjunction with at least one porous substrate layer such as that shown as 15a. The substrate layer(s) 15a is stronger and much more durable than the ePTFE membrane layer(s) 15b making the resulting composite material 15 suitable for use as a filtration media. The sheet of composite material 15 can then be fashioned into a disposable filtration bag 10 as like the one shown in FIGS. 1-3.

The composite sheet 15 can be purchased through commercial sources in roll or sheet form which can then be adapted for use for supplying known filtration bag manufacturing machinery. One commercial supplier of a suitable composite sheet 15 in roll form is BHA Technologies of Kansas City, Mo.

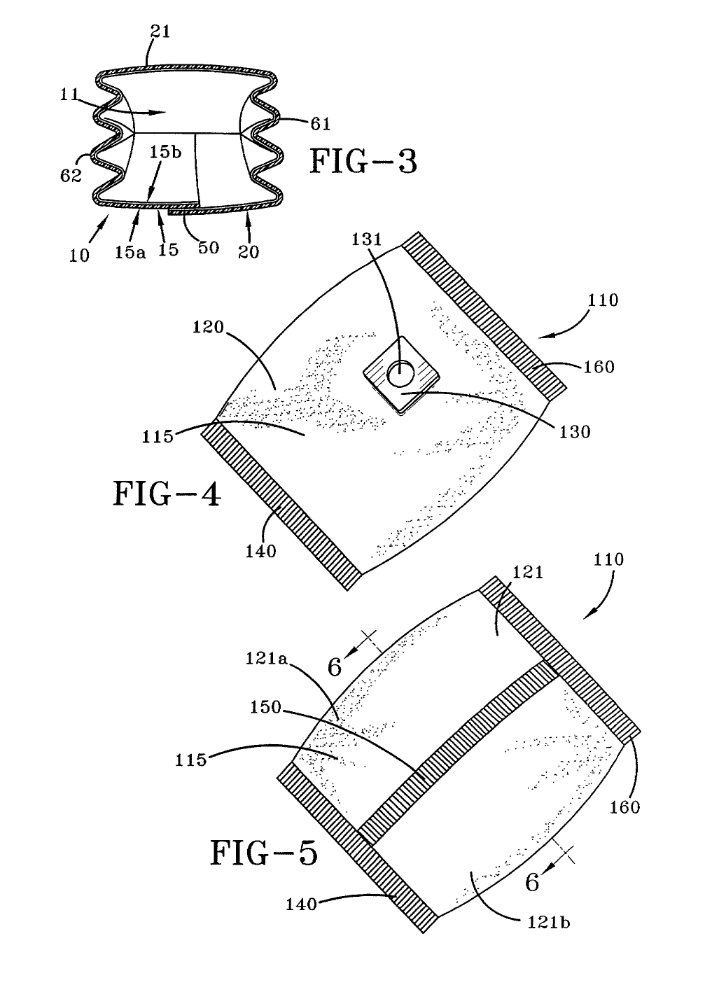

Referring now to FIGS. 4-7, an alternate preferred embodiment of the present invention is shown, wherein a disposable filtration bag 110 is formed from a composite sheet 115 comprised of at least one ePTFE membrane layer 115b and at least one substrate layer 115a. The composite sheet 115 of filtration material may be identical to the composite material 15 in the preferred embodiment which is available from BHA Technologies. The filtration bag 110 is generally rectangular in shape (but does not have to be) and is known as the “pillow case” type filtration bag.

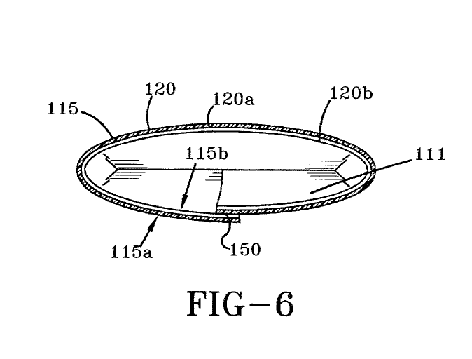

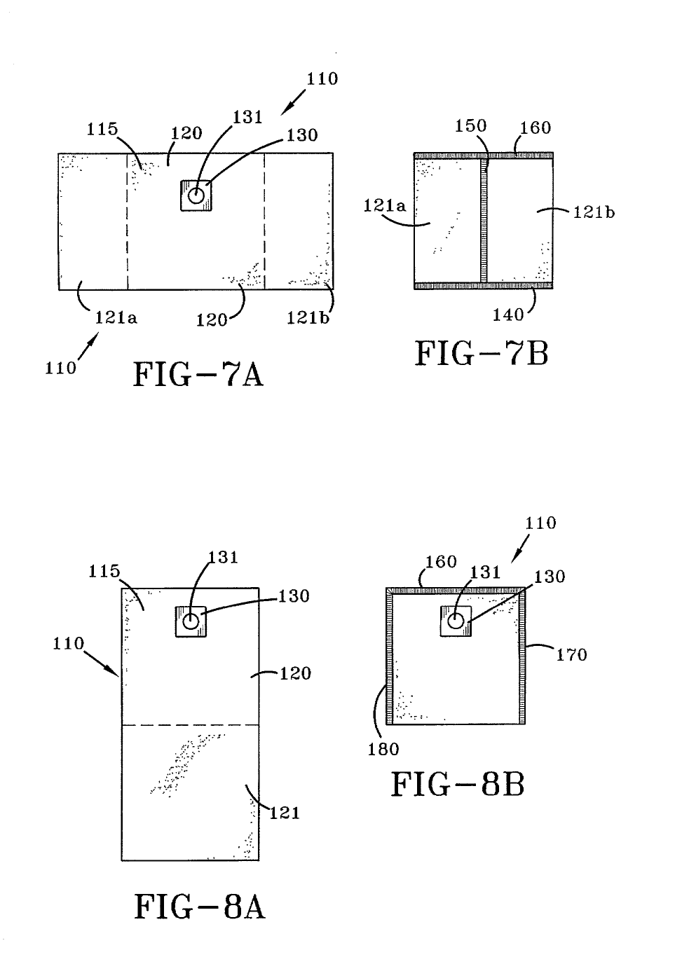

In the alternate embodiment of the invention, filtration bag 110 is made from a single layer of the composite sheet 115 folded over (shown as two dashed lines in FIG. 7a) and sealed along three edges. The filtration bag 110 has no pleats or longitudinal sidewalls. The top edges of front sidewall 120 and rear sidewall 121 are sealed together by a seam 160 which is formed by sewing, adhesives, heat bonding or other suitable methods. The opposing edges of front sidewall 120 and rear sidewall 121 are sealed together by seams 140,160 which are also formed by a suitable method. A seam 150 bonds together two overlapping portions 121a, 121b (shown in FIGS. 7a and 7b) of the panels 121a, 121b (shown in FIGS. 7a and 7b) forming rear sidewall 121. By sealing the top and bottom edges of front sidewall 120 and rear sidewall 121 together by seams 140, 160 and sealing the seam 150 of the opposing panel portions 121a, 121b of the rear panel 121 together, filtration bag 110 is formed having an interior volume 111 as shown in FIG. 6. The dirt particles along with the working air created by a motor fan assembly (not shown) from the suction nozzle (not shown) of the vacuum cleaner or floor care appliance (not shown) enter the filtration bag 110 through an aperture 131 in the front sidewall 120 of filtration bag 110. A collar 130 made from a sheet of stiffer material such as cardboard may be used to reinforce the perimeter of aperture 131 and provide a means by which filtration bag 110 may be supported within the vacuum cleaner and to also hold filtration bag 110 and aperture 131 in alignment with the working air duct of the vacuum cleaner (not shown). Collar 130 may be composed of a single layer of stiff material, or multiple layers of a variety of materials such as a “sandwich” design with a flexible, stretchable material with a smaller diameter aperture on the inside or outside. In an alternate embodiment of means which the filtration bag 110 is connected to the vacuum cleaner or floor care appliance, collar 130 may be replaced by an inlet tube formed from the same or different material as front and rear side walls 120, 121 which then connects aperture 131 to the working air duct of the vacuum cleaner or floor care appliance (not shown).

In another embodiment of the disposable filtration bag 110, filtration bag 110 is formed of a single sheet of composite filtration material 115 folded along one side (shown as the dashed line in FIG. 8a) and sealed along three edges by seam 160 along the top edges of front panel 120 and rear panel 121 and along opposing longitudinal edges of front panel 120 and rear panel 121 by seams 170, 180. As with the other embodiments of the inventions, seams 160, 170, 180 are formed by sewing or adhesives or other suitable methods. By sealing the top and opposing longitudinal edges of front sidewall 120 and rear sidewall 121 together, filtration bag 110 is formed having an interior volume 111 like the embodiment shown in FIG. 6. The dirt particles along with the working air created by a motor-fan assembly (not shown) from the suction nozzle (not shown) of the vacuum cleaner or floor care appliance (not shown) enter the filtration bag 110 through an aperture 131 in the front sidewall 120 of filtration bag 110. A collar 130 made from a sheet of stiffer material such as cardboard may be used to reinforce the perimeter of aperture 131 and provide a means by which filtration bag 110 may be supported within the vacuum cleaner and to also hold filtration bag 110 and aperture 131 in alignment with the working air duct (not shown) of the vacuum cleaner (not shown). Collar 130 may be composed of a single layer of stiff material, or multiple layers of a variety of materials such as a “sandwich” design with a flexible, stretchable material with a smaller diameter aperture on the inside or outside. Alternately, collar 130 may be replaced by an inlet tube formed from the same or different material as front and rear sidewalls 120, 121 which then connects aperture 131 to the working air duct of the vacuum cleaner or floor care appliance (not shown).

In each of the aforementioned embodiments, filtration bag 10 and filtration bag 110 is disposable and can be removed from the vacuum cleaner or floor care appliance (not shown) when full and replaced with another unused and empty disposable filtration bag 10 or disposable filtration bag 110.

Accordingly, the improved disposable filtration bag for a vacuum cleaner is simplified, provides an effective, inexpensive, and efficient device which achieves all of the enumerated objectives. While there has been shown and described herein several embodiments of the present invention, it should be readily apparent to persons skilled in the art that numerous modifications may be made therein without departing from the true spirit and scope of the invention. Accordingly, it is intended by the appended claims to coverall modifications which come within the spirit and scope of the invention.

1. A disposable filtration bag for a floor care appliance, comprising a closed receptacle for collecting dirt particles and having an inlet opening for allowing a dirt laden airstream to enter, said receptacle being formed from a composite sheet comprised of at least one layer of expanded polytetraflouroethylene and at least one substrate layer.

2. The filtration bag of claim 1 wherein said at least one substrate layer is comprised of a material from the group consisting of synthetic fibers and natural fibers.

3. The filtration bag of claim 2 wherein said synthetic fibers is selected from the group consisting of polyester, polyolefin, and nylon.

4. The filtration bag of claim 2 wherein said natural fibers is selected from the group consisting of cellulose and cotton.

5. The filtration bag of claim 1, wherein said closed receptacle further includes:
a front panel portion;
a rear panel portion comprised of a first rear panel portion and a second rear panel portion joined together with a seam;
wherein said front panel portion and said rear panel portion each respectively have a top end and a bottom end and said respective top ends and said bottom ends are sealed together by folding and an adhesive.

6. The filtration bag of claim 5, wherein said closed receptacle further includes a pair of opposing pleated sidewalls joining said front sidewall and said rear sidewall together along the opposing lateral sides.

7. The filtration bag of claim 6, wherein said pair of pleated sidewalls each are comprised of at least one pleat.

8. The filtration bag of claim 1, wherein said closed receptacle further includes:
a front panel portion;
a rear panel portion comprised of a first rear panel portion and a second rear panel portion joined together with a seam;
wherein said front panel portion and said rear panel portion each respectively have a top end and a bottom end and said respective top ends and said bottom ends are sealed together by a seam.

9. The filtration bag of claim 8, wherein the seam sealing said first and second rear panel portions and said seams sealing the respective top ends and said bottom ends of said front and rear panels portions is formed by an adhesive.

10. The filtration bag of claim 8, wherein the seam sealing said first and second rear panel portions and said seams sealing the respective top ends and said bottom ends of said front and rear panels portions is formed by sewing.

11. The filtration bag of claim 8, wherein the seam sealing said first and second rear panel portions and said seams sealing the respective top ends and said bottom ends of said front and rear panels portions is formed by thermal bonding.

12. The filtration bag of claim 8, wherein said closed receptacle is square in shape.

13. The filtration bag of claim 8, wherein said closed receptacle is rectangular in shape.

14. The filtration bag of claim 1, wherein said closed receptacle further includes:
a front panel portion;
a rear panel portion;
wherein said front panel portion and said rear panel portion each have a top and opposing longitudinal edges and said respective top and opposing longitudinal edges are sealed together with a seam.

15. The filtration bag of claim 14, wherein said closed receptacle is square in shape.

16. The filtration bag of claim 14, wherein said closed receptacle is rectangular in shape.

17. The filtration bag of claim 16, wherein the seams sealing said top and opposing longitudinal edges of said front and rear panels are formed by an adhesive.

18. The filtration bag of claim 14, wherein the seams sealing said top and opposing longitudinal edges of said front and rear panels are formed by sewing.

19. The filtration bag of claim 14, wherein the seams sealing said top and opposing longitudinal edges of said front and rear panels are formed by thermal bonding.

20. A method of making a disposable filtration bag for a floor care appliance, comprised of the steps of:
providing a sheet of composite material comprised of at least one layer of expanded polytetraflouroethylene and at least one substrate layer;
folding said sheet of composite material;
sealing together respective edges of a first and second rear panel portion of said receptacle by a seam;
sealing together respective top edges and bottom edges of said receptacle by a seam; and
providing an aperture in a front sidewall of said receptacle wherein a dirt laden airstream may enter.

21. The method of making a disposable filtration bag for a floor care appliance of claim 20, further including one pleated sidewall separating each of said front and rear panel portions along opposing longitudinal edges of said front and rear panel portions.

22. The method of making a disposable filtration bag for a floor care appliance of claim 21, wherein said pleated sidewalls include at least one pleat.

23. A method of making a disposable filtration bag for a floor care appliance, comprised of the steps of:
providing a sheet of composite material comprised of at least one layer of expanded polytetraflouroethylene and at least one substrate layer;
folding said sheet of composite material;
sealing together respective edges of a first and second rear panel portion of said receptacle by a seam;
sealing together respective top edges of a front and rear panel portion of said receptacle by a seam; and
providing an aperture in a front sidewall of said receptacle wherein a dirt laden airstream may enter.

24. A method of making a disposable filtration bag for a floor care appliance, comprised of the steps of:
providing a sheet of composite material comprised of at least one layer of expanded polytetraflouroethylene and at least one substrate layer;
folding said sheet of composite material;
sealing together respective top edges of a front and rear panel portion of said receptacle by a seam;
sealing together respective opposing longitudinal edges of a said front and rear panel portions of said receptacle by a seam; and
providing an aperture in a front sidewall of said receptacle wherein a dirt laden airstream may enter.

25. A vacuum cleaner, comprised of:
a suction nozzle;
a motor-fan assembly; and
a disposable filtration bag formed from a composite sheet comprised of at least one layer of expanded polytetraflouroethylene and at least one substrate layer.

26. A floor care appliance, comprised of:
a suction nozzle;
a motor-fan assembly; and
a disposable filtration bag formed from a composite sheet comprised of at least one layer of expanded polytetraflouroethylene and at least one substrate layer.
